(19) United States
(12) Patent Application Publication
(10) Pub. No.: US 2014/0049851 A1
(43) Pub. Date: Feb. 20, 2014

(54) DEVICE AND RELATED SYSTEMS AND METHODS FOR SECURING ACCESSORIES TO HAND HELD ELECTRONIC DEVICES

(71) Applicants: Scott Snell, Los Angeles, CA (US); Robert Galzarano, Los Angeles, CA (US)

(72) Inventors: Scott Snell, Los Angeles, CA (US); Robert Galzarano, Los Angeles, CA (US)

(21) Appl. No.: 13/589,670

(22) Filed: Aug. 20, 2012

(51) Int. Cl. F16M 13/02; G02B 7/182; F16M 11/00

(52) U.S. Cl. 359/871; 248/205.1; 248/688

(57) ABSTRACT

The present invention includes devices and related systems and methods for securing accessories to a mobile electronic device. In one embodiment, a device and system for attaching a decorative accessory to a mobile phone is provided. The device and system comprise of a connector base sized to fit the audio jack of a mobile phone and an attachment platform for one or more decorative or functional accessories that is removably attached to the connector base. In one aspect of at least one embodiment, the connector base is comprised of a continuous shaft with two ends and attached near one end to a pin which inserts into the audio jack. In one aspect of at least one embodiment, the attachment platform is comprised of a clip, pivot assembly and shoulder on which the accessory resides.

### BACKGROUND

1. Field of the Disclosure

The present invention relates to systems and methods for securing accessories to hand held electronic devices. In particular, but not by way of limitation, the present invention relates to systems and methods for securing accessories to hand held electronic devices with standard audio/microphone jacks.

2. General Background

Handheld electronic devices are compact, portable electronic products. Examples of handheld electronic devices include mobile phones, cellular phones, smartphones such as the iPhone®, pocket personal computers (Pocket PCs), personal digital assistants (PDAs), BlackBerries, palmtops, PMPs (portable media player such as the iPod®), tablet computers such as the iPad®, e-readers such as the Kindle®, laptops, notebook computers, and netbook computers.

As these handheld electronic devices have become more feature rich, smaller and more affordable, the popularity and adoption of these devices has grown rapidly both in the United States and worldwide.

Only a few methods exist in the prior art to personalize and accessorize these hand held electronic devices. Generally, these comprise snap-on plates or “skins”, protective cases that alter the ornamental appearance, stickers, glue-ons and other adhesive methods, or simple built-in or stick-on lanyard attachment points for connecting a decorative lanyard. The prior art does not offer any feasible and universal method to securely and temporarily connect accessories of different shapes and sizes while providing angling and positioning control over these accessories.

Accessorizing hand held electronic devices has presented a significant challenge because of the variety of shapes, sizes and manufacturing materials used in producing them. In addition, hand held electronic device designs are rapidly changing and evolving, which can quickly make an existing accessory obsolete. Also, protective cases for smartphones, for example, change the dimensions of the phone in various ways, thus preventing a standard securing method. Moreover, hand held electronic devices are often used in a variety of settings and stored and carried in a variety of ways, so durability of any accessory connection system is important. It is thus apparent that there is a need in the art for an improved system and method for securing accessories to hand held electronic devices.

The vast majority of hand held electronic devices include a standard 3.5 mm stereo audio jack or stereo plus microphone audio jack or in some cases a 2.5 mm audio jack. Audio jack placement varies from device to device. These differences make it difficult to design an accessory connection system that fits a majority of hand held electronic devices.

The present invention provides a solution to accessorize a hand held electronic device by enabling secure accessory attachment and positioning control regardless of the underlying device design and often regardless of whether the device is enclosed in a protective case or skin. In turn, this invention provides a quick, simple and inexpensive way to personalize virtually any hand held electronic device.

The present invention consists of a system and method comprised of a smart phone device, a connector base, an attachment platform, and an ornament/object/accessory. A smart phone user may securely (but not permanently) attach to a smart phone device any number of available 2D and 3D objects, including: 3D figurines, bobble heads, licensed characters from any number of entertainment categories, 2D objects such as banners or buttons, and battery/USB-powered objects (e.g. fans, lights, sound-enabled objects that chirp, buzz or talk, etc.). In addition, a smart phone user may attach a variety of useful/functional objects to his device, such as: (1) “Sun Shade or Awning” (a system and method to provide sun shade control while utilizing a smart phone device outdoors); (2) a safety whistle; (3) a paper clip to hold papers and pictures; (4) a functional solar panel for trickle charging; (5) a business card holder; (6) a stylus for tapping/typing on a smart phone device; (7) sunglass holder; 8) a front-facing convex minor to see ahead while texting and walking; 8) fun gadgets such as a miniature “Magic Eight Ball”. This arrangement will allow users to personalize, ornament, and differentiate a smart phone device.

### SUMMARY

A system and method for securing accessories to hand held electronic devices is described. Embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

A “connector base” is herein described as a small pin that properly holds/orients the base (shaft) in the correct position to support the object/attachment/accessory/ornament/utility. The connector base may come in the following varieties: 1) a 3.5 mm L shaped connector base consisting of a 3.5 mm pin and integrated shaft that is not audio or voice functional; 2) a 3.5 mm L shaped connector base consisting of a fully functional L-shaped clip containing a 3 mm stereo and/or voice enabled male pin and female receptacle and that is audio/voice functional; 3) a 2.5 mm version of the L-shaped connector base; 4) a straight cylinder version consisting of a 3.5 mm pin and straight shaft; 5) a two-part cylinder with a bendable elbow/hinge between the non-functional 3.5 mm pin end and the remainder of the cylinder; 6) a two-part cylinder with a bendable elbow/hinge between the functional 3.5 mm pin end and the remainder of the cylinder; 7) a two-part cylinder with a bendable elbow/hinge between a multi-purpose pin end (functional and nonfunctional) and the remainder of the cylinder; 8) a T-shaped version of a 3.5 mm shaped connector base; 9) a “pegboard” version of the connector base described in subsections above consisting of a connector base (and a 3.5 mm pin) made of mini pegboard holes into which any pegged object can be securely attached; 10) a “personalization clip” consisting of a 3.5 mm pin and a fixed loop through which a lanyard, keychain, or other dangling object can be affixed; (11) (12) pin design variations, which can include (a) pins designed to serve a functional or a non-functional purpose; (b) ribbed pins to minimize pin from sliding out; (c) jagged pins (e.g. a vacuum hose connection) to prevent the pin from sliding out; and (d) a pressure-style pin (i.e. a small compressible oval shape that, once in the audio jack wants to stay in); (11) a bendable and telescoping connector base; (12) a telescoping connector base that supports kick-stand like functionality for the device. Designs to minimize rotation about the pin include soft plastic that will not break or a tacky, squeezable surface between the shoulder.

An “attachment platform” is herein defined as a C-shaped clip and pivot assembly comprised of a shoulder and rivet pin adjacent to and opposite the open portion of the C-clip and a second shoulder with centered hole through which the rivet pin connects and holds the accessory and fixed objects/attachments/accessories. Variations on the attachment platform include: (1) a C-clip design comprised of a c-shaped clip attached directly to an object with a type of intermediary between the object and the C-clip; (2) a C-clip with no swivel; (3) a C-clip with a 360-degree swivel; (4) a C-clip with a ball-and-joint swivel; (5) an O-shaped clip that is permanently fixed to the shaft and with an attached ½ snap (the other ½ affixed to the object).

One embodiment of the present disclosure is a device and system for attaching a decorative accessory to a smartphone, the device and system comprising a smartphone with an audio jack, a connector base and an attachment platform for the decorative accessory (FIG. 1). The connector base is comprised of a continuous shaft with two ends and attached near one end to a pin which inserts into the audio jack. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. Both ends of the shaft contain pin sized female receptacles to enable modular additional connector bases. This arrangement allows the accessory to securely attach to the smartphone while allowing the accessory to be rotated about the shaft, positioned along the shaft and rotated about the pin.

One embodiment of the present disclosure is a device and system for attaching a decorative accessory to a smartphone, the device and system comprising a smartphone with an audio jack, a connector base and an attachment platform for the decorative accessory. The connector base is comprised of a continuous shaft with two ends each containing pin sized female receptacles to enable modular additional connector bases. About the shaft and on any position along the shaft attach the pin assembly and separately the attachment platform via O-clip or C-clip (FIG. 1). The clips independently secure the attachment platform and the pin to the shaft of the connector base anywhere along the shaft between the two ends and allow rotation about the axis of the shaft and movement along the length of the shaft. The attachment platform clip is comprised of a ball/socket which allows rotation and tilt of the object about the ball. This arrangement allows the accessory to securely attach to the smartphone while allowing the accessory to be rotated about the shaft, positioned along the shaft and rotated about the pin.

One embodiment of the present disclosure is “FrontSee”—a system and method comprised of a smartphone device, a connector base, an attachment platform, and a convex mirror (FIG. 7). With FrontSee, a walking pedestrian can see both ahead and laterally in order to avoid bumping into people or objects while texting or browsing on the smartphone device. Alternatively, instead of a convex minor wherein the world is “upside down”, FrontSee can also be comprised of two minors: a forward positioned flat minor that faces the phone and a rear facing (larger) convex mirror that faces forward. This arrangement acts as a mini periscope that allows the user to see the world in front of them from a right-side-up perspective.

One embodiment is a system for attaching a decorative accessory to a smartphone along with ‘kickstand’ functionality, the system comprising a smartphone with an audio jack, a connector base and an attachment platform for the decorative accessory. The two modular bases are attached together forming an “L” shaped structure which supports both; landscape and portrait viewing mode. The connector base is comprised of a continuous shaft with two ends and attached near one end to a pin which inserts into the audio jack. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. Both ends of the shaft contain pin sized female receptacles to enable modular additional connector bases. Into either shaft end can be inserted a kickstand attachment which provides portrait or landscape hands-free viewing of the smartphone. This arrangement allows the accessory to securely attach to the smartphone while allowing the accessory to be rotated about the shaft, positioned along the shaft and rotated about the pin.

In another embodiment of the present disclosure, a system for the attachment assembly of the kickstand device to the hand held device via the connector base is provided (See FIG. 2). In an aspect of at least one embodiment, the upper end of the kickstand device comprises of a hinge allowing pivotal movement of the kickstand device. The lower end of the kickstand device comprises of a ball joint allowing rotational movement of the kickstand device. The connector base comprises of a peg that fits into the audio jack of the handheld device. In yet another embodiment a system utilizing the connector base as a ‘kickstand’ function that allows viewing of the hand held device at an angle.

In yet another kickstand embodiment, a system for attaching a decorative accessory to a smartphone, the system comprising a smartphone with an audio jack, a connector base and an attachment platform for the decorative accessory. The connector base is comprised of at least one telescoping shaft within an outermost shaft which is attached near one end to a pin which inserts into the audio jack. The end opposite the pin can be extended to form a continuous shaft of decreasing dimensions with a stabilizing foot at the end (FIG. 3). The attachment platform is comprised of a clip, pivot assembly and shoulder on which the accessory resides. The clip secures the attachment platform to the outermost shaft of the connector base anywhere along the outermost shaft between the two ends and allows rotation about the axis of the shaft and movement along the length of the shaft. This arrangement allows the accessory to securely attach to the smartphone while allowing the accessory to be rotated about the shaft, positioned along the shaft and rotated about the pin. In addition, the telescoping internal shafts provide ‘kickstand’ functionality to the smartphone for portrait or landscape viewing mode.

In yet another kickstand embodiment is a system for attaching a decorative accessory to a smartphone, the system comprising a smartphone with an audio jack, a connector base and an attachment platform for the decorative accessory. The connector base is comprised of at least one telescoping shaft within an outermost shaft which is attached near one end to a pin which inserts into the audio jack. The end opposite the pin can be extended to form a continuous shaft of decreasing dimensions. The innermost shaft is hinged connected to its parent shaft via a telescoping hinge assembly. The innermost hinged leg may be bent up to 90 degrees perpendicular to its parent shaft to form a solid ‘kickstand’ base. The attachment platform is comprised of a clip, pivot assembly and shoulder on which the accessory resides. The clip secures the attachment platform to the outermost shaft of the connector base anywhere along the outermost shaft between the two ends and allows rotation about the axis of the shaft and movement along the length of the shaft. This arrangement allows the accessory to securely attach to the smartphone while allowing the accessory to be rotated about the shaft, positioned along the shaft and rotated about the pin. In addition, the telescoping internal shafts and hinged inner-shaft provide ‘kickstand’ functionality to the smartphone for portrait or landscape viewing mode.

In yet another embodiment is a system for attaching a decorative accessory to a smartphone, the system comprising a smartphone with an audio jack, a connector base and an attachment platform for the decorative accessory. The connector base is comprised of a continuous shaft with two ends and attached near one end to a compression pin which inserts into the audio jack. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. Both ends of the shaft contain pin sized female receptacles to enable modular additional connector bases. This arrangement allows the accessory to securely attach to the smartphone while allowing the accessory to be rotated about the shaft, positioned along the shaft and rotated about the pin.

In yet another embodiment is a system for attaching a decorative accessory to a smartphone, the system comprising a smartphone with an audio jack, a connector base and an attachment platform for the decorative accessory. The connector base is comprised of a continuous shaft with two ends and attached at one end to a pin via ball-joint which inserts into the audio jack. The ball-joint allowing the shaft to be positioned from zero degrees up to ninety degrees perpendicular to the pin in any direction in conjunction with rotating about the pin. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. One end of the shaft contains pin sized female receptacles to enable modular additional connector bases. This arrangement allows the accessory to securely attach to the smartphone while allowing the accessory to be rotated about the shaft, positioned along the shaft and rotated about the pin.

In yet another embodiment is a system for attaching a decorative accessory to a smartphone, the system comprising a smartphone with an audio jack, a connector base and an attachment platform for the decorative accessory. The connector base is comprised of a continuous shaft with two ends and attached near one end to a pin via a roller wheel which inserts into the audio jack. The roller wheel allows the shaft to be positioned from zero degrees up to ninety degrees perpendicular to the pin in a single plane but in any direction in conjunction with rotating about the pin. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. One end of the shaft contains a pin sized female receptacle to enable modular additional connector bases. This arrangement allows the accessory to securely attach to the smartphone while allowing the accessory to be rotated about the shaft, positioned along the shaft and rotated about the pin.

In yet another embodiment is a system for attaching a decorative accessory with a sliding pin to a smartphone, the system comprising a smartphone with an audio jack, a connector base and an attachment platform for the decorative accessory. The connector base is comprised of a continuous shaft with two ends and attached to a pin via a sliding track which inserts into the audio jack. The sliding track allows the pin to slide from one end of the shaft to the other and anywhere in between allowing the shaft to be easily positioned along the smartphone. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. Both ends of the shaft contain pin sized female receptacles to enable modular additional connector bases. This arrangement allows the accessory to securely attach to the smartphone while allowing the accessory to be rotated about the shaft, positioned along the shaft which itself can be positioned and rotated about the pin.

In yet another embodiment is a system for attaching a decorative accessory to a smartphone, the system comprising a smartphone with an audio jack, a connector base and an attachment platform for the decorative accessory. The connector base is comprised of a continuous rotating internal shaft with two ends and covered by an external continuous rotating sleeve and attached near one raised edge end of the internal shaft to a pin which inserts into the audio jack. The rotating sleeve may be round and smooth, round with peg holes, round with pegs, notched, ridged, or any number of shapes (e.g., square, octagonal, etc.,) to enable secure attachment of the similarly sized clip to the external rotating sleeve. The attachment platform is comprised of a clip, pivot assembly and shoulder on which the accessory resides. The clip secures the attachment platform to the shaft of the connector base anywhere along the shaft between the two ends and allows rotation about the axis of the shaft and repositioning along the length of the shaft. Both ends of the shaft contain pin sized female receptacles to enable modular additional connector bases. This arrangement allows the accessory to securely attach to the smartphone while allowing the accessory to be rotated about the shaft, positioned along the shaft and rotated about the pin.

In yet another embodiment is a system for attaching a decorative accessory to a smartphone, the system comprising a smartphone with an audio jack, a connector base and an attachment platform for the decorative accessory. The connector base is comprised of a continuous internal shaft with two ends and covered by an external partial and sliding rotating sleeve and attached near one end to a pin which inserts into the audio jack. The rotating sleeve maybe round and smooth, round with peg holes, round with pegs, notched, ridged, or any number of shapes (e.g., square, octagonal, etc.,) to enable secure attachment of the clip to the external rotating sleeve. The attachment platform is comprised of a clip, pivot assembly and shoulder on which the accessory resides. The clip secures the attachment platform to the external sleeve of the connector base which itself can be positioned anywhere along the shaft between the two ends and allowing rotation about the axis of the shaft and movement along the length of the shaft. Both ends of the shaft contain pin sized female receptacles to enable modular additional connector bases. This arrangement allows the accessory to securely attach to the smartphone while allowing the accessory to be rotated about the shaft, positioned along the shaft and rotated about the pin.

In yet another embodiment is a system for attaching a decorative accessory to a smartphone, the system comprising a smartphone with an audio jack, a connector base and an attachment platform for the decorative accessory. The connector base is comprised of a continuous grooved shaft with two ends and attached near one end to a pin which inserts into the audio jack. The attachment platform is comprised of a clip, pivot assembly and shoulder on which the accessory resides. The clip secures the attachment platform to the shaft of the connector base anywhere along the shaft between the two ends along any groove, allowing movement along the length of the shaft. Both ends of the shaft contain pin sized female receptacles to enable modular additional connector bases. This arrangement allows the accessory to securely attach to the smartphone while allowing the accessory to be rotated about the shaft by selecting the appropriate groove, positioned along the shaft and rotated about the pin.

In yet another embodiment is a system for attaching a decorative accessory to a smartphone, the system comprising a smartphone with an audio jack, a connector base and an attachment platform for the decorative accessory. The connector base is comprised of a continuous shaft with two ends and attached near one end to a pin which inserts into the audio jack. The attachment platform is comprised of an O ring, pivot assembly and shoulder on which the accessory resides. The O ring clip secures the attachment platform to the shaft of the connector base anywhere along the shaft between the two ends and allows rotation about the axis of the shaft and movement along the length of the shaft. Both ends of the shaft contain pin sized female receptacles to enable modular additional connector bases. This arrangement allows the accessory to securely attach to the smartphone while allowing the accessory to be rotated about the shaft, positioned along the shaft and rotated about the pin.

In yet another embodiment is a system for attaching a decorative accessory to a smartphone, the system comprising a smartphone with a USB jack, a connector base and an attachment platform for the decorative accessory. The connector base is comprised of a continuous shaft with two ends and attached near one end to a USB pin which inserts into the USB jack of the smartphone. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. This arrangement allows the accessory to securely attach to the smartphone while allowing the accessory to be rotated about the shaft, and positioned along the shaft.

In yet another embodiment is a system for attaching a decorative accessory to a smartphone, the system comprising a smartphone with an audio jack, a connector base and an attachment platform for the decorative accessory. The connector base is comprised of a shaft housing on both ends at least one internal telescoping shaft within its outer shaft. A pin which inserts into the audio jack attaches to the primary shaft in the middle between both telescoping ends. Each end can be extended to form a continuous shaft of decreasing dimensions. Each telescoping end contains a pin sized female receptacle to enable modular additional connector bases. The attachment platform is comprised of a clip, pivot assembly and shoulder on which the accessory resides. The clip secures the attachment platform to the shaft of the connector base anywhere along the outer shaft between the two ends and allows rotation about the axis of the shaft and movement along the length of the shaft. This arrangement allows the accessory to securely attach to the smartphone while allowing the accessory to be rotated about the shaft, positioned along the shaft and rotated about the pin. In addition, the telescoping internal shafts provide ‘kickstand’ functionality to the smartphone for portrait or landscape viewing mode.

In yet another embodiment is a system for attaching a decorative accessory to a smartphone, the system comprising a smartphone with an audio jack, a connector base and an attachment platform for the decorative accessory. The connector base is comprised of at least one telescoping shaft within an outermost shaft which is attached at one end to a pin which inserts into the audio jack. One end of the shaft can be extended to form a continuous telescoping shaft of decreasing dimensions. The attachment platform is comprised of a similarly sized pin, pivot assembly and shoulder on which the accessory resides. The pin secures the attachment platform to either end of the shaft of connector base and allows rotation about the axis of the shaft and the telescoping end allows lateral movement of the attachment platform when pinned to that end. The pin sized female receptacles on either end of the shaft enable modular additional connector bases or attachment platforms. This arrangement allows the accessory to securely attach to the smartphone while allowing the accessory to be rotated about the shaft, positioned along the shaft and rotated about the pin.

In yet another embodiment is a system for attaching a decorative accessory to a smartphone, the system comprising a smartphone with an audio jack, a connector base and an attachment platform for the decorative accessory. The connector base is comprised of a flat surface with four edges and attached at one edge to a pin via a ball or roller type joint which inserts into the audio jack. The connector base contains along its upper surface peg holes into which allow the attachment platform to securely connect into any matching hole on the connector base. The attachment platform opposite the peg end contains a shoulder on which the accessory resides. This arrangement allows the accessory to securely attach to the smartphone at any peg/hole location along the connector base while allowing the accessory to be angled up or down according to the ball joint/roller joint and rotated as needed about the pin. In addition, the peg hole is sized the same as the smartphone audio jack to allow modular and multiple connection arrangements.

In yet another embodiment is a system for attaching a decorative accessory to a smartphone, the system comprising a smartphone with an audio jack, a connector base and an attachment platform for the decorative accessory. The connector base is comprised of a bendable square shaped shaft and attached at one end to a pin which inserts into the audio jack. The connector base contains along the length of its surface opposite the pin a series of peg holes into which the attachment platform can securely connect. The attachment platform pin is sized the same as the connector base pin to support modularity. The attachment platform consists of a pin attached to a pivot assembly on which the accessory resides. This arrangement allows the accessory to securely attach to the smartphone at any peg/hole location along the connector base while allowing the accessory to be angled according to the limits of the bendable connector base and rotated as needed about the pin and rotated as needed about the pivot assembly.

In yet another embodiment is a system for attaching a decorative accessory to a smartphone, the system comprising a smartphone with an audio jack, a connector base and an attachment platform for the decorative accessory. The connector base is comprised of a square shaped shaft and attached at one end to a pin which inserts into the audio jack. The connector base contains along the length of its surface opposite the pin a series of peg holes into which the attachment platform can securely connect. The attachment platform pin is sized the same as the connector base pin to support modularity. The attachment platform consists of a pin attached to a pivot assembly on which the accessory resides. This arrangement allows the accessory to securely attach to the smartphone at any peg/hole location along the connector base while allowing the accessory to be rotated as needed about the pin and rotated as needed about the pivot assembly.

In yet another embodiment is a system for attaching a decorative accessory to a smartphone, the system comprising a smartphone with an audio jack, a connector base and an attachment platform for the decorative accessory. The connector base is comprised of a square shaped shaft and attached at one end via a roller wheel joint to a pin which inserts into the audio jack. The connector base contains along the length of its surface opposite the pin a series of peg holes into which the attachment platform can securely connect. The attachment platform pin is sized the same as the connector base pin to support modularity. The attachment platform consists of a pin attached to a pivot assembly on which the accessory resides. This arrangement allows the accessory to securely attach to the smartphone at any peg/hole location along the connector base while allowing the accessory to be rotated as needed about the roller wheel joint, about the pin and rotated as needed about the pivot assembly.

In yet another embodiment is a system for attaching a decorative accessory to a smartphone, the system comprising a smartphone with an audio jack, a connector base and an attachment platform for the decorative accessory. The connector base is comprised of a spherical surface and attached at one edge to a pin via a ball or roller type joint which inserts into the audio jack. The connector base contains along its surface peg holes into which allow the attachment platform to securely connect into any matching hole on the connector base. The attachment platform opposite the peg end contains a shoulder on which the accessory resides. Each peg/hole is sized to allow modular connections of additional peg balls. This arrangement allows the accessory to securely attach to the smartphone at any peg/hole location around the surface of the connector base while allowing the accessory to be angled up or down according to the ball joint/roller joint and rotated as needed about the pin.

In yet another embodiment is a system for attaching a decorative accessory to a smartphone, the system comprising a smartphone with an audio jack, a connector base and an attachment platform for the decorative accessory. The connector base is comprised of a disc and attached at one edge to a pin which inserts into the audio jack. The connector base contains along its continuous outer edge peg holes into which allow the attachment platform to securely connect into any matching hole on the connector base. The attachment platform opposite the peg end contains a shoulder on which the accessory resides. Each peg/hole is sized to allow modular connections of additional peg discs. This arrangement allows the accessory to securely attach to the smartphone at any peg/hole location around the continuous edge of the connector base while allowing the accessory to be rotated as needed about the pin.

In yet another embodiment is a system for attaching a decorative accessory to a smartphone, the system comprising a smartphone with an audio jack, a connector base and an attachment platform for the decorative accessory. The connector base is comprised of a pin which inserts into the audio jack, and connected to a flexible/bendable wire/hose/cable that holds when positioned and connected to an attachment platform which has a pivoting shoulder on which the accessory resides. This arrangement allows the accessory to securely attach to the smartphone while allowing the accessory to be positioned near the audio jack as allowed by the flexible hose and rotated about the pin.

In yet another embodiment is a system for attaching a decorative accessory to a smartphone, the system comprising a smartphone with an audio jack and a connector base with attached pivoting platform which anchors the decorative accessory. The connector base is comprised of a pin connected to the ball end of a ball-joint structure which itself anchors a bouncy coil spring that connects to a pivot assembly and shoulder on which the accessory resides. This arrangement allows an object to be temporarily and securely attached to the smartphone while allowing the object to bounce/jiggle and to be rotated: around the pivot; around the pin; and moveable around the limits of the ball joint.

In yet another embodiment is a system for attaching a decorative accessory to a smartphone, the system comprising a smartphone with an audio jack and a connector base with attached (springy) platform which anchors the decorative accessory. The connector base is comprised of two parallel shoulders connected to each other by a bouncy coil spring (FIG. 5). Connected to the edge of one shoulder, and perpendicular to it, is a pin which inserts into the audio jack. The opposite shoulder anchors a pivot assembly and shoulder on which the accessory resides. This arrangement allows an object to be temporarily and securely attached to the smartphone while allowing the object to bounce/jiggle and to be rotated around the pivot and around the pin.

In yet another embodiment is a system for attaching a decorative accessory to a smartphone, the system comprising a smartphone with an audio jack and a connector base with attached (springy) platform which anchors the decorative accessory. The connector base is comprised of two parallel discs connected to each other by a bouncy coil spring (FIG. 5). Connected to the bottom of one disk, and extending from the bottom of it, is a pin which inserts into the audio jack. The opposite disc anchors a stub assembly on which the accessory resides. This arrangement allows an object to be temporarily and securely attached to the smartphone while allowing the object to bounce/jiggle and to be rotated around the axis of the pin.

In yet another embodiment is a system for attaching a decorative accessory to a smartphone, the system comprising a smartphone with an audio jack and a connector base with attached pivoting platform which anchors the decorative accessory. The connector base is comprised of a pin connected to the ball end of a ball-joint structure which itself anchors a pivot assembly and shoulder on which the accessory resides. This arrangement allows an object to be temporarily and securely attached to the smartphone while allowing the object to be rotated: around the pivot; around the pin; and moveable around the limits of the ball joint.

In yet another embodiment is a system for attaching a decorative accessory to a smartphone, the system comprising a smartphone with an audio jack and a connector base with attached platform which anchors the decorative accessory. The connector base is comprised of a shoulder which anchors a pivot assembly and shoulder on which the accessory resides. Connected to the edge of one shoulder, and perpendicular to it, is a pin which inserts into the audio jack. This arrangement allows an object to be temporarily and securely attached to the smartphone while allowing the object to be rotated around the pivot and around the pin.

In yet another embodiment is a system for attaching a decorative accessory to a smartphone, the system comprising a smartphone with an audio jack and a connector base with attached platform which anchors the decorative accessory. The connector base is comprised of two shoulders connected to each other by a hinge. Connected to the edge of one shoulder, and perpendicular to it, is a pin which inserts into the audio jack. The opposite hinged shoulder anchors a pivot assembly and shoulder on which the accessory resides. This arrangement allows an object to be temporarily and securely attached to the smartphone while allowing the object to be moved along the axis of the hinge; and to be rotated around the pivot and around the pin.

In yet another embodiment is a system for attaching a decorative accessory to a smartphone, the system comprising a smartphone with an audio jack and a connector base with attached (springy) platform which anchors the decorative accessory. The connector base is comprised of two parallel shoulders connected to each other by a bouncy coil spring. Connected to the edge of one shoulder, and perpendicular to it, is a pin which inserts into the audio jack. The opposite shoulder anchors a hinge to which another shoulder is connected. This hinged shoulder anchors a pivot assembly and shoulder on which the accessory resides. This arrangement allows an object to be temporarily and securely attached to the smartphone while allowing the object to bounce/jiggle; and to be moved along the axis of the hinge; and to be rotated around the pivot and around the pin.

In yet another embodiment is a system for attaching a decorative accessory to a smartphone, the system comprising a smartphone with an audio jack and a dust cover. The dust cover comprised of a disc connected to a pin that extends perpendicularly from the base of the disc. This arrangement allows the disc to operate as a dust cover that is temporarily and securely attached to the smartphone.

In yet another embodiment is a system for attaching a decorative accessory to a smartphone, the system comprising a smartphone with an audio jack and a connector disk. The connector disc is comprised of a disc connected to a pin that extends perpendicularly from the base of the disc. The connector disc contains an eye hole through the entire disc directly through the edge parallel to the pin. This arrangement allows decorative material to be looped through the eye hole that is temporarily and securely attached to the smartphone.

In yet another embodiment is a system for attaching a decorative accessory to a smartphone, the system comprising a smartphone with an audio jack and a telescoping stylus (FIG. 8 and FIG. 9). The telescoping stylus is comprised of one telescoping shaft within an outermost shaft which is attached near one end to a pin which inserts into the audio jack. The end opposite the pin can be extended to form a continuous shaft of decreasing dimensions with a stylus tip, capacitive or non-capacitive, for interacting with and manipulating touch based devices. This arrangement allows the compressed telescoping stylus to securely attach to the smartphone when not in use.

In yet another embodiment is a system for attaching a decorative accessory to an iPhone, the system comprising a iPhone with an audio jack, a connector base and an attachment platform for the decorative accessory (FIG. 6). The connector base is comprised of a continuous shaft with two ends and attached near one end to a compression pin which inserts into the audio jack. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. Both ends of the shaft contain pin sized female receptacles to enable modular additional connector bases. This arrangement allows the accessory to securely attach to the iPhone while allowing the accessory to be rotated about the shaft, positioned along the shaft and rotated about the pin. In addition to an iPhone, the system works with any other electronic device with a suitable audio jack or USB port, including tablets, android-based cell phones, laptops, and e-readers.

In yet another embodiment of the present disclosure is a device and system for attaching a decorative accessory to a smartphone, the device and system comprising a smartphone with an audio jack, a connector base and an attachment platform for the decorative accessory. The connector base is comprised of a continuous shaft with two ends and attached near one end to a pin which inserts into the audio jack. The attachment platform is comprised of a clip, ball/socket pivot assembly and shoulder on which the accessory resides. The clip secures the attachment platform to the shaft of the connector base anywhere along the shaft between the two ends and allows rotation about the axis of the shaft and movement along the length of the shaft. One end of the shaft contains a pin sized female receptacle to enable modular additional connector bases. This arrangement allows the accessory to securely attach to the smartphone while allowing the accessory to be rotated about the shaft, positioned along the shaft and rotated about the pin.

In yet another embodiment of the present disclosure is a device and system for attaching a decorative accessory to a smartphone, the device and system comprising a smartphone with an audio jack, a connector base and an attachment platform for the decorative accessory. Rubberizing certain portions of the connector base and the telescoping aids stability for the kickstand attachment.

In yet another embodiment is a system for attaching a decorative accessory to a smartphone, the system comprising a smartphone with an audio jack, a connector base and an attachment platform for the decorative accessory. The connector base is comprised of a continuous shaft with two ends and attached to a pin via a sliding track which inserts into the audio jack. The sliding track allows the pin to slide from one end of the shaft to the other and anywhere in between allowing the shaft to be easily positioned along the smartphone. On one end of the shaft is a rotating arm containing a ball on one end for ball/socket connection to the object and attached at the other end to the shaft via a rivet to allow full 360 rotation of the arm around the end of the shaft. This arrangement allows the accessory to securely attach to the smartphone while allowing the accessory to be rotated about the shaft, positioned along the shaft which itself can be positioned and rotated about the pin.

In yet another embodiment is a system for attaching a decorative accessory to a smartphone, the system comprising a smartphone with an audio jack and a connector base with attached platform which anchors the decorative accessory. The connector base is comprised of a continuous shaft, angled as needed, to conform to a specific smartphone design. At one end of the shaft is the pin which inserts into the audio jack. At the other end of the shaft is a simple ball for a ball/socket attachment of the object to the connector base. This arrangement allows an object to be temporarily and securely attached to the smartphone while allowing the object to be rotated around the ball/socket and around the pin.

In yet another embodiment of the present disclosure is a device and system for attaching a decorative accessory to a smartphone, the device and system comprising a smartphone with an audio jack, a connector base and an attachment platform for the decorative accessory. The connector base is comprised of a continuous slotted shaft with two ends and attached near one end to a pin which inserts into the audio jack. The attachment platform is comprised of a clip, pivot assembly and shoulder on which the accessory resides. The clip secures the attachment platform to the shaft of the connector base at any slot along the shaft between the two ends and allows rotation about the axis of the shaft. Both ends of the shaft contain pin sized female receptacles to enable modular additional connector bases. This arrangement allows the accessory to securely attach to the smartphone while allowing the accessory to be rotated about the shaft, positioned along the shaft and rotated about the pin.

In yet another embodiment of the present disclosure is a device and system for attaching a decorative accessory to a smartphone, the device and system comprising a smartphone with an audio jack, a pin which inserts into the audio jack which is connected directly or via hinge to a flat surface with two sides onto which are attached banners, promotions or images, a type of miniature billboard for the smart phone. This arrangement allows the billboard to securely attach to the smartphone.

In yet another embodiment of the present disclosure is a device and system for attaching a decorative accessory to a smartphone, the system comprising a smartphone with an audio jack, and a connector base. The connector base is comprised of two sections joined by a moveable hinge (FIG. 8). One section of the connector base contains a sized hole to receive an audio jack housing such as an iphone earphone jack or a non-functional pin which connects into the audio jack of the smartphone. The other section of the connector base contains at least one telescoping shaft which can extend from or retract into the connector base. The tip end of the telescoping section contains a capacitive (or non-capacitive) stylus tip which serves to provide a stable base for the kick stand as well as a functional stylus for data entry/manipulation on the smartphone device. The hinge between the two sections of the connector base serves to improve the elevation of the kickstand while in portrait mode and allows the connector base to be folded out of the way when not being used.

In yet another embodiment of the present disclosure, a system for attaching a decorative accessory to a smartphone is provided, the system comprising a smartphone with an audio jack, and a connector base. The connector base is comprised of two sections joined by a moveable hinge (FIG. 9). One section of the connector base contains a functional 3.5 mm male to female audio/stereo/mic. The other section of the connector base contains at least one telescoping shaft which can extend from or retract into the connector base. The tip end of the telescoping section contains a capacitive (or non-capacitive) stylus tip which serves to provide a stable base for the kick stand as well as a functional stylus for data entry/manipulation on the smartphone device. The hinge between the two sections of the connector base serves to improve the elevation of the kickstand while in portrait mode and allows the connector base to be folded out of the way when not being used.

In yet another embodiment, a system for attaching a decorative accessory to a smartphone is provided. The system comprising a smartphone with an audio jack, a connector base and an attachment platform for the decorative accessory. The connector base is comprised of a continuous shaft with a slotted end adjacent to a sized hole to receive an audio jack housing such as a smartphone (e.g., iphone) earphone jack or a non-functional pin which connects into the audio jack of the smartphone. The attachment platform is comprised of a clip, pivot assembly and shoulder on which the accessory resides. The clip secures the attachment platform to the shaft of the connector base anywhere along the shaft between the two ends and allows rotation about the axis of the shaft and movement along the length of the shaft. This arrangement allows the accessory to securely attach to the smartphone with a functional audio connection or a non-functional audio connection while allowing the accessory to be rotated about the shaft, positioned along the shaft and rotated about the pin.

In yet another embodiment, a device and system for attaching a promotional message or branding message to a smartphone while providing kickstand functionality is provided. The device and system comprising a smartphone with an audio jack, a pin which inserts into the audio jack at an angle to optimize elevation of the kickstand and which is connected to a flat or rounded surface long enough to serve as a leg for the kickstand and designed to receive any type of promotional or branded text or imagery. At the end of the surface opposite the pin is attached a capacitive stylus tip to serve as a foot for the kickstand and also a functional hand held stylus. This arrangement allows the promotional item to be visible while in use as a kickstand in either portrait or landscape mode.

Yet another kickstand embodiment is a device and system for elevating a smartphone in portrait or landscape kickstand mode, the device and system comprising a smartphone with an audio jack, a pin which inserts into the audio jack and a decorative elongated object such as a dolphin. This arrangement allows the smartphone to be supported in either portrait or landscape mode while utilizing a desired object as the kickstand.

Yet another embodiment is a system for attaching a decorative accessory to a smartphone, the system comprising a smartphone with an audio jack, audio jack headphones, an audio jack sleeve with attachment platform, a connector base and attachment platform for the decorative accessory (FIG. 8). The connector base is comprised of a continuous shaft with two ends and attached near one end to a pin which inserts into the audio jack. The pin end of the shaft contains a hole sized to match the insert from the audio jack sleeve male end. The end opposite the pin end contains one or more telescoping sections to provide kickstand functionality. The audio jack sleeve with attachment platform clips around the housing near the 3.5 mm audio headphone pin and contains a platform and male attachment end. This arrangement allows the accessory to securely attach to the connector base which can insert directly into the smartphone audio jack or indirectly via the audio jack sleeve to support functional use of the headphones. In addition, an object may attach to the connector base via a c-clip arrangement or directly to the audio jack sleeve attachment platform.

In yet another embodiment is a system for attaching a functional accessory to a smartphone, the system comprising a smartphone with an audio jack, audio jack headphones, a connector base and attachment platform designed as a cord wrap. The connector base is comprised of a continuous shaft with a slotted end adjacent to a sized hole to receive an audio jack housing such as an iphone earphone jack or a non-functional pin which connects into the audio jack of the smartphone. The attachment platform is comprised of a clip, pivot assembly and frame around which the headphone cord can be conveniently wrapped. The clip secures the attachment platform to the shaft of the connector base anywhere along the shaft between the two ends and allows rotation about the axis of the shaft and movement along the length of the shaft. This arrangement allows the accessory to securely attach to the smartphone with a functional audio connection or a nonfunctional connection while allowing the headphone cord to be conveniently stowed when not in use.

Yet another embodiment is a system for attaching a decorative accessory to a smartphone, the system comprising a smartphone with an audio jack, audio jack headphones, and an audio jack sleeve with attachment platform. The connector base in this case is the audio jack sleeve and connected to it, either by clipping onto it or sliding over it, is the attachment platform which contains a built-in swivel mechanism and onto which attaches the accessory. This arrangement allows the accessory to securely attach to the audio jack sleeve which can insert directly into the smartphone audio jack to support functional use of the headphones.

### BRIEF DESCRIPTION OF THE DRAWINGS

The above-mentioned features and objects of the present disclosure will become more apparent with reference to the following description taken in conjunction with the accompanying drawings wherein like reference numerals denote like elements and in which:

FIG. 1 shows, in accordance with at least one embodiment of the present disclosure, a connector base consisting of a pin fixed to a continuous shaft with modular ends of the shaft. FIG. 1 also shows an attachment base with decorative piece with respective connector base sliding peg. As shown in the figure, the connector base consists of a pin fixed to a continuous shaft with modular ends of the shaft. The connector base is attached to a smartphone via the pin of the connector base and the audio jack of the smartphone. An attachment platform which carries an accessory or ornament connects to the connector base.

FIG. 2 shows, in accordance with another embodiment of the present disclosure, a side elevational view connector base and attachment platform having a different attachment means.

FIG. 3 shows, in accordance with yet another embodiment of the present disclosure, a connector base and a yet another attachment platform having a different attachment means.

FIG. 4 shows, in accordance with yet another embodiment of the present disclosure, a connector base and attachment platform having a different attachment means.

FIG. 5 shows, in accordance with yet another embodiment of the present disclosure, a connector base and attachment platform having a different attachment means.

FIG. 6 shows, in accordance with yet another embodiment of the present disclosure, a connector base and attachment platform having a different attachment means.

FIG. 7 shows, in accordance with yet another embodiment of the present disclosure, a connector base and attachment platform with attached minor.

FIG. 8 shows, in accordance with yet another embodiment of the present disclosure illustrates an attachment assembly for the hand held electronic device via the connector base. The attachment system attaches the connector base to a hand held device alternatively through a connector base attachment device.

FIG. 9 shows, in accordance with yet another embodiment of the present disclosure, a connector base and attachment platform having a different functional attachment means.

### DETAILED DESCRIPTION OF THE DRAWINGS

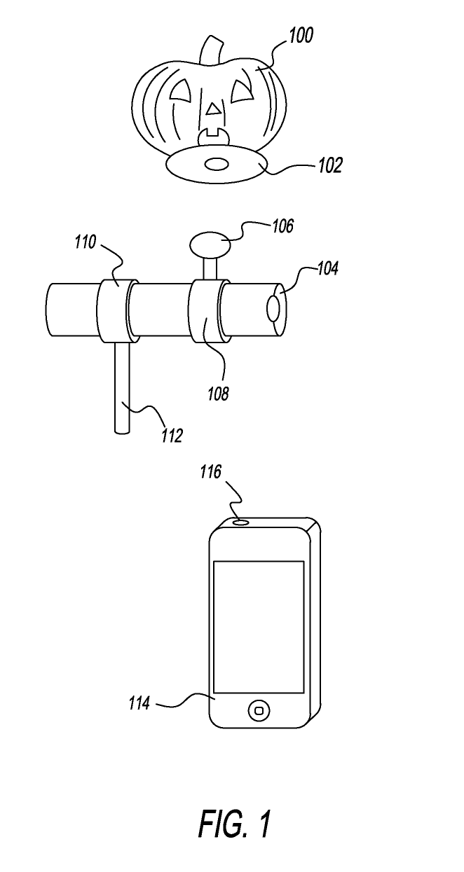

Referring now to the drawings, where like or similar elements are designated with identical reference numerals throughout the several views, and referring in particular to FIG. 1, it illustrates a method for attaching a decorative accessory (100) to a handheld device (114) item in accordance with an embodiment of the invention. In the embodiment of FIG. 1, the decorative accessory (100) is attached to a handheld device (114) via the connector base (104) into the audio jack (116) of the smart phone (114). The connector base (104) is a continuous shaft having two attachments on its surface. The first attachment comprises of a pin (108) and an O ring (106) and the second attachment comprises of a peg (112) and an O ring or C clip (110). The first attachment of the connector base (104) connects the decorative accessory (100) to the connector base (104) where the attachment platform (102) of the decorative accessory (100) fits onto the pin (106) of the connector base (104). The second attachment of the connector base (104) connects the connector base (104) with the smart phone (114). The peg (112) of the connector base (104) fits into the audio jack (116) of the handheld device (114). A handheld device (114) is shown in FIG. 1 for purposes only. In other embodiments, the hand held electronic device may be a type other than a smartphone. In yet other embodiments, decorative accessory (100) can be attached to other hand held electronic devices, including, without limitation, mobile phones, cellular phones, smartphones such as the iPhone®, pocket personal computers (Pocket PCs), personal digital assistants (PDAs), BlackBerries, palmtops, PMPs (portable media player such as the iPod®), tablet computers such as the iPad®, e-readers such as the Kindle®, laptops, notebook computers, and netbook computers with audio jacks for insertion of a securing portion of system. For example, an iPad consisting of an audio jack can connect to the connector base and decorative assembly.

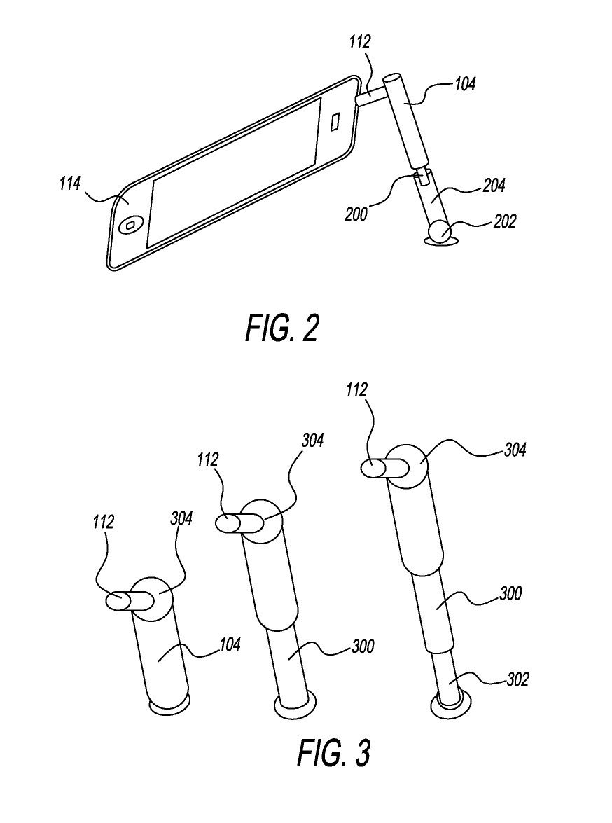

FIG. 2 illustrates in one aspect of at least one embodiment of the present disclosure the side elevational view of the attachment assembly. The attachment assembly as shown in the figure comprises of the handheld device (114) connected to the kickstand device (204) via the connector base (104). The upper end of kickstand device (204) comprises of a hinge (200) allowing pivotal movement of the kickstand device (204). The lower end of the kickstand device (204) comprises of a ball joint (202) allowing rotational movement of the kickstand device (204). As shown in the figure peg (112) of the connector base (104) fits into the audio jack of the handheld device (114). FIG. 2 illustrates a system where the connector base is utilized for a ‘kickstand’ function that allows viewing of the hand held device (114) at an angle on a surface.

FIG. 3 illustrates another embodiment for the attachment assembly for the handheld device via a connector base. As shown in FIG. 3, the attachment system comprises of the connector base (104) and the kickstand device. The attachment system comprises of telescoping movement which can be retracted and extended based on the height required by the user. As shown in the figure, in another aspect of at least one embodiment, the kickstand device (300) can be retracted into the connector base (104). In yet another aspect of at least one embodiment, the kickstand device can be extended (302). The peg (112) of the connector base (104) of the attachment system comprises of a ball joint (304) allowing the pivotal movement of the attachment system. FIG. 3 illustrates a system where the connector base (104) is utilized for a ‘kickstand’ function that allows viewing of the hand held device at an angle on a surface.

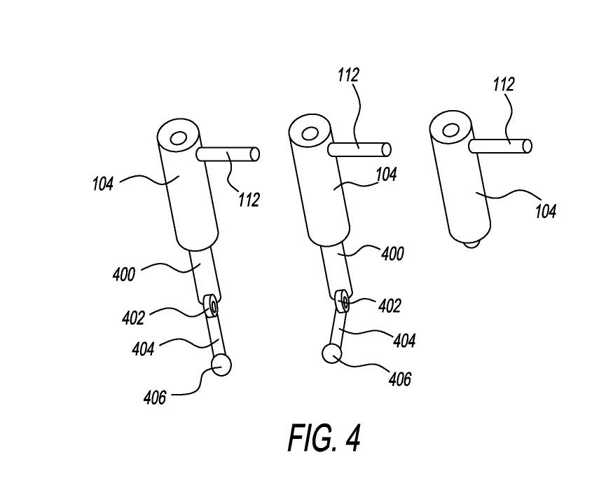

FIG. 4 illustrates yet another embodiment for the attachment assembly for the hand held electronic device via a connector base. As shown in FIG. 4, the kickstand device is attached to the connector base (104). The kickstand device comprises of a hinge (402) which allows the pivotal movement of the attachment assembly in more than one axis. As shown in the figure the presence of the hinge allows the lower end (404) of the kickstand device to slide into the upper end (400) of the kickstand device. The lower end of the kickstand device comprises of a ball joint (406) allowing rotational movement of the attachment assembly. In yet another aspect of at least one embodiment the kickstand device can be extended or retracted from the connector base (104) based on the requirement of the user. FIG. 4 illustrates a system where the connector base (104) is utilized for a ‘kickstand’ function that allows viewing of the hand held device at an angle on a surface.

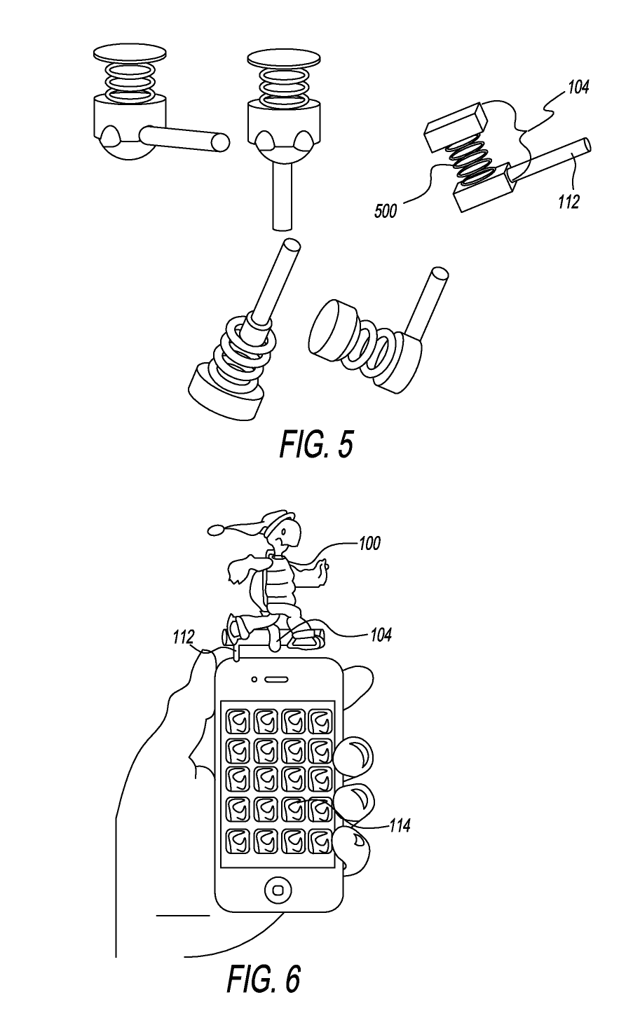

FIG. 5 illustrates yet another embodiment of the attachment assembly for the hand held electronic device via the connector base. The peg (112) of the connector base (104) fits into the audio jack of the hand held device. The connector base (402) of the attachment system comprises of a spring mechanism (500) as shown in FIG. 5. The connector base (104) is comprised of a pin connected to the ball end of a ball-joint structure which itself anchors a bouncy coil spring (500) that connects to a pivot assembly and shoulder on which the accessory resides. This arrangement allows an object to be temporarily and securely attached to the smartphone while allowing the object to bounce/jiggle and to be rotated: around the pivot; around the pin; and moveable around the limits of the ball joint.

FIG. 6 illustrates yet another embodiment for the attachment of the decorative accessory to the hand held electronic device via the connector base. As shown in the figure the accessory (100) for the hand held electronic device attached onto the hand held electronic device (114) via the peg (112) of the connector base (104).

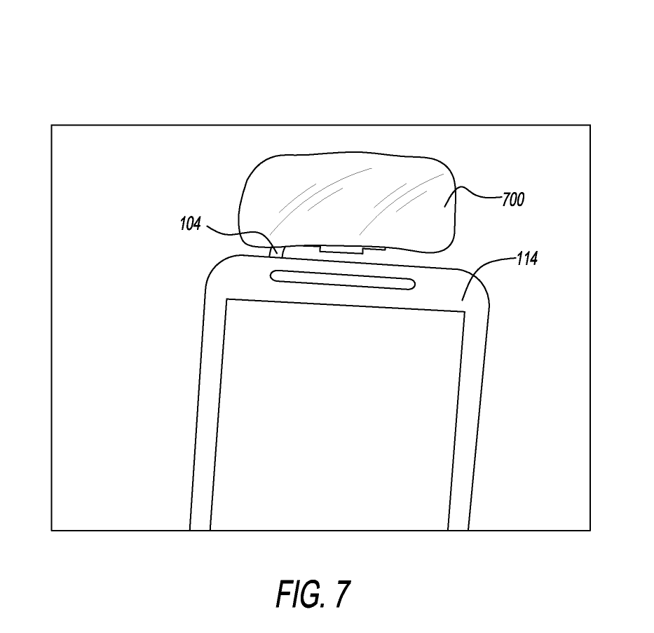

FIG. 7 illustrates yet another embodiment for the attachment of the decorative accessory to the hand held electronic device via the connector base. As shown in FIG. 7 the system attaches a convex minor (700) connected on the C clip of the connector base (104) which is attached onto the hand held electronic device (114). In one aspect of the present embodiment the convex mirror attached on the hand held electronic device aids the users who walk while texting.

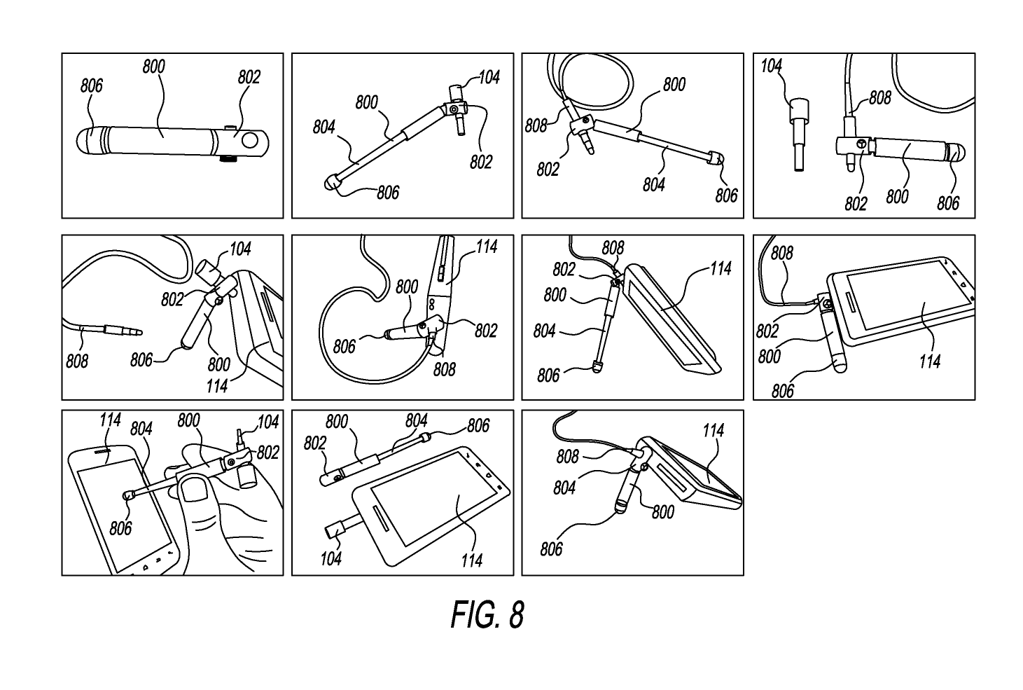

FIG. 8 illustrates yet another embodiment of the attachment assembly for the hand held electronic device via the connector base. The attachment system attaches the connector base to a hand held device alternatively through a connector base attachment device. The connector base attachment device (800) comprises of telescoping movement allowing the user to adjust the height based on his requirement where the connector base attachment device (800) is utilized for a ‘kickstand’ function that allows viewing of the hand held device at an angle on a surface. As shown in the FIG. 8, the connector base attachment device (800) is tubular in shape. The top of the connector base attachment device (800) comprises of a ball joint (802) allowing the pivotal movement of the connector base attachment device with regards to the hand held device. The base (806) of the connector base attachment device (800) has dual purpose. In one aspect of one embodiment the base (806) of the connector base attachment device (800) serves as the foot for the ‘kickstand’ attachment system and in another aspect of another embodiment the base (806) of the connector base attachment device (800) serves as a stylus. In one embodiment the connector base (104) passes through the connector base attachment device (800) attaching the connector base attachment device (800) with the hand held device. The FIG. 8 shows various mechanisms by which the connector base (104) and the connector base attachment device (800) are connected to the hand held device. In yet another aspect of at least one embodiment the system attaches to a connector base through an interchangeable pin rather than the fixed pin as illustrated in the figure. There are several types of pins that be used interchangeably with a connector base that does not have a fixed pin. The figure illustrates a system that the same connector base can be used with another pin.

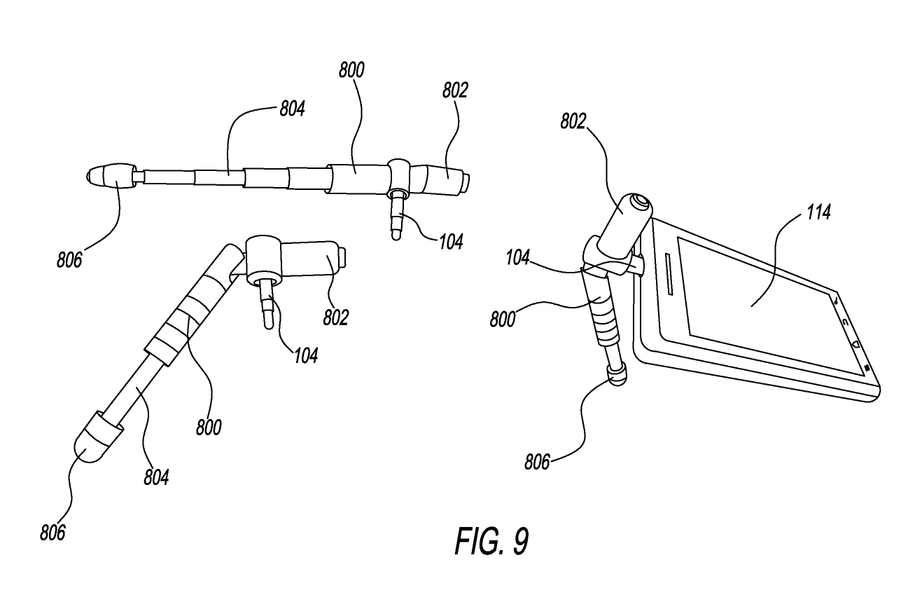

FIG. 9 illustrates yet another embodiment of the attachment assembly for the hand held electronic device via the connector base. The attachment system attaches the connector base to the hand held electronic device. FIG. 9 shows the connector base and the connector base attachment device are pre-attached to each other. As shown in the FIG. 9, the connector base of the present disclosure comprises of a ball joint allowing pivotal movement of the connector base. The connector base comprises of telescoping movement and serves as a ‘kickstand’ function that allows viewing of the hand held device at an angle on a surface. The FIG. 9 shows the attachment of the connector device to the hand held electronic device in landscape as well as portrait positions. The figure shows the side elevational view of the connector base and the connector base attachment device connected to the handheld device at an angle on the surface. The figure illustrates a system for attaching a decorative accessory to a hand held electronic device via a connector base. The decorative accessory is attached via a clip. Different decorative accessories can utilize different attachment mechanisms. The figure also illustrates a system, where a decorative accessory is attached to a connector base by an O-ring.

In yet another embodiment of the present disclosure, various objects including but not limited to kickstands, decorative accessories, minor and springs can be attached to the connector base of the attachment assembly.

In yet another aspect of at least one embodiment, the system attaches the connector base to a hand held electronic device via the pin attached to a 3.5 mm audio jack of the hand held electronic device. In other embodiments, a system can also function with a connector base with a 2.5 mm audio jack, utilizing a pin for 2.5 mm jacks.

In yet another aspect of at least one embodiment, some decorative accessories attach through multiple connections. In yet another aspect of at least one embodiment, a system that attaches a decorative accessory using a pin between the connector base and the decorative accessory. In yet another aspect of at least one embodiment, a system with a decorative accessory attached to a connector base through a secondary connector base sphere.

In yet another aspect of at least one embodiment, the decorative accessories can also be utilized for a functional purpose. In yet another aspect of at least one embodiment, a system where the connector base is utilized for a ‘kickstand’ function that allows viewing of the hand held device at an angle on a surface.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

We claim:

1. A device for use with a mobile device, the device comprising:
a connector base sized to fit the 3.5 mm audio jack of mobile device removably connected to an attachment platform that allows one or more functional or decorative accessories to be removably attached to the attachment platform or the connector base.

2. The device of claim 1, wherein the device further comprises a minor that attaches to the attachment platform or the connector base allowing the user the ability to see in front of the mobile device while using the mobile device.

3. The device of claim 1, wherein the attachment platform and connector base acts as a stand that supports the mobile device.

4. The device of claim 1, wherein the attachment platform telescopes.

5. The device of claim 1, wherein the connector base is sized to fit a clip containing an ornamental object.

6. The device of claim 1, wherein the connector base is spring loaded.

7. The device of claim 1, wherein the attachment platform is spring loaded.

8. The device of claim 1, further comprising a clip.

9. The device of claim 8, wherein the clip is spring loaded.

10. The device of claim 1, further comprising a pivot assembly.

11. A device for use with a mobile device, the device comprising:
a connector base sized to fit the audio jack of mobile device; connected to an attachment platform that is adapted to allow one or more functional or decorative accessories to be removably attached to the attachment platform.

12. The device of claim 11, wherein the device further comprises a minor that attaches to the attachment platform or the connector base allowing the user the ability to see in front of the mobile device while using the mobile device.

13. The device of claim 11, wherein the attachment platform or connector base acts as a stand that supports the mobile device.

14. The device of claim 11, wherein the attachment platform telescopes.

15. The device of claim 11, wherein the connector base is sized to fit a clip containing an ornamental object.

16. The device of claim 11, wherein the connector base is spring loaded.

17. The device of claim 11, wherein the attachment platform is spring loaded.

18. The device of claim 11, further comprising a clip.

19. The device of claim 18, wherein the clip is spring loaded.

20. The device of claim 11, further comprising a pivot assembly.
